(19) United States
(12) Patent Application Publication
(10) Pub. No.: US 2023/0246473 A1
(43) Pub. Date: Aug. 3, 2023

(54) Mobile power supply

(71) Applicant: HU RUAN, SHENZHEN (CN)

(72) Inventor: HU RUAN, SHENZHEN (CN)

(21) Appl. No.: 17/588,287

(22) Filed: Jan. 30, 2022

(51) Int. Cl. H02J 7/34; H02J 7/00; H01M 50/107

(52) U.S. Cl. CPC H02J 7/342; H02J 7/0042; H02J 7/0047; H01M 50/107; H01M 2220/30

(57) ABSTRACT

A mobile power supply, includes a shell, a charging interface, a battery, and a light supplementing lamp. At least one part of the shell is in a cylindrical shape, the shell is configured to bear a photographing device, and the shell is fixedly connected with the photographing device. The charging interface is disposed on the shell, and the charging interface is configured to be electrically connected to the photographing device. The battery is disposed in the shell, and the battery is configured to charge the photographing device through the charging interface. The light supplementing lamp is disposed on the shell, and the light supplementing lamp is configured as an external light source of the photographing device.

### TECHNICAL FIELD

The present disclosure relates to a technical field of electronics, and in particular to a mobile power supply.

### BACKGROUND

At present, there are some devices (such as digital cameras and miniature cameras) in the market which cannot replace batteries, so that long-time shooting requirements cannot be achieved. In prior art, when power of a photographing device, whose battery cannot be replaced, is insufficient, charging may be performed through a mobile power supply. However, existing mobile power supplies are generally, configured to charge a mobile phone, and the mobile power supply for charging the photographing device is also the mobile power supply for charging the mobile phone, resulting in that the mobile power supply only has a single function and cannot meet needs of users.

### SUMMARY

Embodiments of the present disclosure provide a mobile power supply, having a plurality of functions and meeting a plurality of requirements of users.

The present disclosure provide the mobile power supply, including a shell, a charging interface, a battery, and a light supplementing lamp.

At least one part of the shell is in a cylindrical shape, the shell is configured to bear a photographing device, and the shell is fixedly connected with the photographing device.

The charging interface is disposed on the shell, and the charging interface is configured to be electrically connected to the photographing device.

The battery is disposed in the shell, and the battery is configured to charge the photographing device through the charging interface.

The light supplementing lamp is disposed on the shell, and the light supplementing lamp is configured as an external light source of the photographing device.

Optionally, the shell includes a holding part, and a functional part, the light supplementing lamp and the charging interface are disposed in the functional part, and the holding part is in the cylindrical shape.

Optionally, the functional part, includes a first flat area and a second flat area where the first flat area and the second flat area are oppositely disposed, and two arc-shaped areas oppositely disposed. The first flat area and the second flat area are connected through the two arc-shaped areas. The charging interface is disposed in the first flat area, and the light supplementing lamp is disposed in the second flat area.

Optionally, the mobile power supply further includes a control button. The control button is electrically connected with the light supplementing lamp, and the control button is configured to control the light supplementing lamp to switch different brightness levels.

Optionally, the control button is disposed in the first flat area.

Optionally, the mobile power supply further includes a plurality of prompting lamps, and the plurality of prompting lamps are configured to prompt remaining power of the battery.

Optionally, the plurality of prompting lamps are disposed side by side.

Optionally, the mobile power supply further includes at least one signal lamp, and the at least one signal lamp is configured to prompt the battery to be in a charging state or in a discharging state.

Optionally, the signal lamp is disposed around the charging interface.

Optionally, the shell further includes a connecting plug and a connecting socket, the connecting plug and the connecting socket are respectively disposed at two opposite ends of the shell, the connecting plug is configured to be connected with a connecting socket of other device, and the connecting socket is configured to be connected with a connecting plug of other device.

Optionally, the mobile power supply further includes a circuit board, the circuit board is disposed in the shell, and the circuit board is connected with the battery to control charging and discharging of the battery.

Optionally, the circuit board includes a first driving circuit. The first driving circuit includes a first control chip and a seventeenth resistor. The first control chip includes a first pin, a second pin, and a third pin. The mobile power supply further includes a first prompting lamp, a second prompting lamp, a third prompting lamp, and a fourth prompting lamp.

A positive electrode of the first prompting lamp is connected with the first pin, and a negative electrode of the first prompting lamp is connected with the third pin through the seventeenth resistor.

A negative electrode of the second prompting lamp is connected with the first pin, and a positive electrode of the second prompting lamp is connected with the third pin through the seventeenth resistor.

A positive electrode of the third prompting lamp is connected with the second pin, and a negative electrode of the third prompting lamp is connected with the third pin through the seventeenth resistor.

A negative electrode of the fourth prompting lamp is connected with the second pin, and a positive electrode of the fourth prompting lamp is connected with the third pin through the seventeenth resistor.

Optionally, the circuit board further includes a charging and discharging matching circuit. The charging and discharging matching circuit includes a first resistor, a first transistor, a second transistor, a ninth resistor, and a third transistor.

One end of the first resistor is connected with the first control pin of the first control chip.

A grid electrode of the first transistor is connected with the first control pin, a drain electrode of the first, transistor is connected with a voltage input pin of the first control chip, and a source electrode of the first transistor is connected with an other end of the first resistor.

A grid electrode of the second transistor is connected with the first control pin, a drain electrode of the second transistor is connected with the charging interface, and a source electrode of the second transistor is connected with the other end of the first resistor.

One end of the ninth resistor is connected with a voltage output pin of the first control chip.

A grid electrode of the third transistor is connected with the second control pin of the first control chip, the grid electrode of the third transistor is further connected with an other end of the ninth resistor, a source electrode of the third transistor is connected with the voltage output pin, and a drain electrode of the third transistor is connected with the charging interface.

Optionally, the circuit board includes a second driving circuit, and the second driving circuit includes a second control chip and a first matching circuit.

The second control chip includes a switching pin and a first output pin, and the switching pin is configured to receive a signal of a control switch.

The first matching circuit includes a twelfth resistor, a fifteenth resistor, a sixteenth resistor, and a fourth transistor. One end of the twelfth resistor is connected with an other end of the battery, and an other end of the twelfth resistor is connected with a positive electrode of the light supplementing lamp. One end of the fifteenth resistor is connected with the first output pin, an other end of the fifteenth resistor is connected with a grid electrode of the first transistor, and the other end of the fifteenth resistor is electric grounding through the sixteenth resistor. The drain electrode of the first transistor is connected with a negative electrode of the light supplementing lamp, and the source electrode of the first transistor is electric grounding.

Optionally, the circuit board further includes a second matching circuit. The second matching circuit includes an eleventh resistor. One end of the eleventh resistor is connected with a second output pin of the second control chip, an other end of the eleventh resistor is connected with a positive electrode of the signal lamp, and a negative electrode of the signal lamp is electric grounding.

Optionally, the circuit board further includes a third driving circuit. The third driving circuit includes a third control chip, a fifth transistor, a sixth transistor, a seventh transistor, and an eighth transistor.

The third control chip includes a power supply pin, a VSS pin, a CS pin, a first charging and discharging control pin, and a second charging and discharging control pin.

A grid electrode of the fifth transistor is connected with the first charging and discharging control pin, and a source electrode of the fifth transistor is connected with the VSS pin.

A grid electrode of the sixth transistor is connected with the first charging and discharging control pin, and a source electrode of the sixth transistor is connected with the VSS pin.

A grid electrode of the seventh transistor is connected with the second charging and discharging control pin, a source electrode of the seventh transistor is electric grounding through a VSS port, and a drain electrode of the seventh transistor is connected with a drain electrode of the fifth transistor.

A grid electrode of the eighth transistor is connected with the second charging and discharging control pin, a source electrode of the eighth transistor is electric grounding through the VSS port, and a drain electrode of the eighth transistor is connected with a drain electrode of the sixth transistor.

Optionally, the third driving circuit further includes a tenth resistor, a thirteenth resistor, and a tenth capacitor.

One end of the tenth resistor is connected with the power supply pin, and an other end of the tenth resistor is connected with a positive electrode of the battery.

One end of the thirteenth resistor is connected with the CS pin, and an other end of the thirteenth resistor is electric grounding.

One end of the tenth capacitor is connected with the power supply pin, and an other end of the tenth capacitor is connected with the VSS pin.

In the embodiments of the present disclosure, the mobile power supply not only charges the photographing device, but also provides the light supplementing lamp to cooperate with the photographing device for shooting, so that shooting effect of the photographing device is improved. In addition, the shell of the mobile power supply not only carries the photographing device, but also is fixedly connected with the photographing device. A user may lift the photographing device through holding the mobile power supply, and it is not necessary to hold the mobile power supply and the photographing device at the same time, which is convenient for the user to carry and use the photographing device and the mobile power supply. The shell of the mobile power supply has at least one part to be in a cylindrical structure, and the cylindrical structure is very convenient for the user to hold with single hand. The user may conveniently hold and move the mobile power supply by holding the cylindrical shell with the single hand, so that the photographing device fixedly connected with the mobile power supply is further moved along with the mobile power supply, and when the mobile power supply charges the photographing device, the photographing device may continue to capture images. Therefore, the mobile power supply of the embodiments may provide the plurality of functions and meet the plurality of requirements of the users.

### BRIEF DESCRIPTION OF DRAWINGS

In order to illustrate technical solutions in embodiments of the present disclosure more clearly, drawings required in description of the embodiments will be briefly described below. Obviously, the drawings in the following description are merely some embodiments of the present disclosure, and for a person skilled in art, other drawings may further be obtained from the drawings without creative efforts.

For a more complete understanding of the present disclosure and the beneficial effects thereof, the following description will be made with reference to the accompanying drawings, wherein same reference numerals refer to same parts in the following description.

FIG. 1 is a structural schematic diagram of a mobile power supply 10 according to one embodiment of the present disclosure.

FIG. 2 is a structural schematic diagram of the mobile power supply 10 shown in FIG. 1 where the mobile phone supply 10 is shown in another angle.

FIG. 3 is an exploded schematic diagram of the mobile power supply 10 shown in FIG. 1.

FIG. 4 is a structural schematic diagram of the mobile power supply 10 shown in FIG. 1 where the mobile phone supply 10 is shown in another angle.

FIG. 5 is a structural schematic diagram of the mobile power supply 10 shown in FIG. 1 where the mobile phone supply 10 is shown in another angle.

FIG. 6 is a circuit diagram of a first driving circuit according to one embodiment of the present disclosure.

FIG. 7 is a circuit diagram of a charging and discharging matching circuit according to one embodiment of the present disclosure.

FIG. 8 is a circuit diagram of a second driving circuit and a second matching circuit according to one embodiment of the present disclosure.

FIG. 9 is a circuit diagram of a third driving circuit according to one embodiment of the present disclosure.

### DETAILED DESCRIPTION

Technical solutions in embodiments of the present disclosure are clearly and completely described below with reference to accompanying drawings in the embodiments of the present disclosure. Obviously, the described embodiments are only a part of the embodiments of the present disclosure, rather than all of the embodiments. All other embodiments obtained by a person skilled in art based on the embodiments of the present disclosure without creative efforts shall fall within a protection scope of the present disclosure.

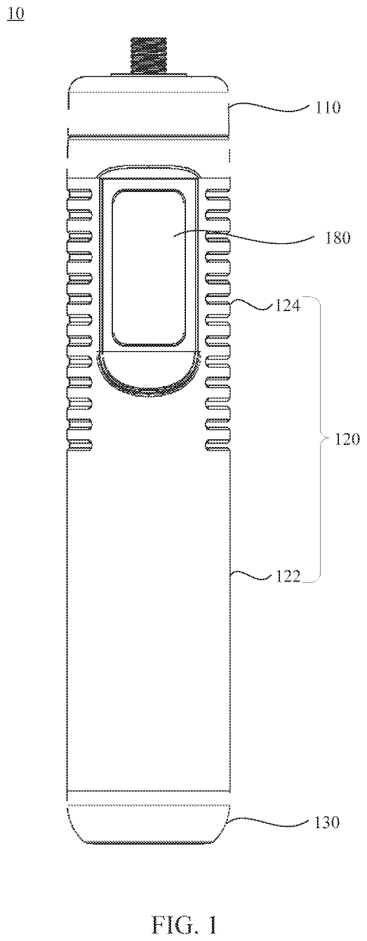

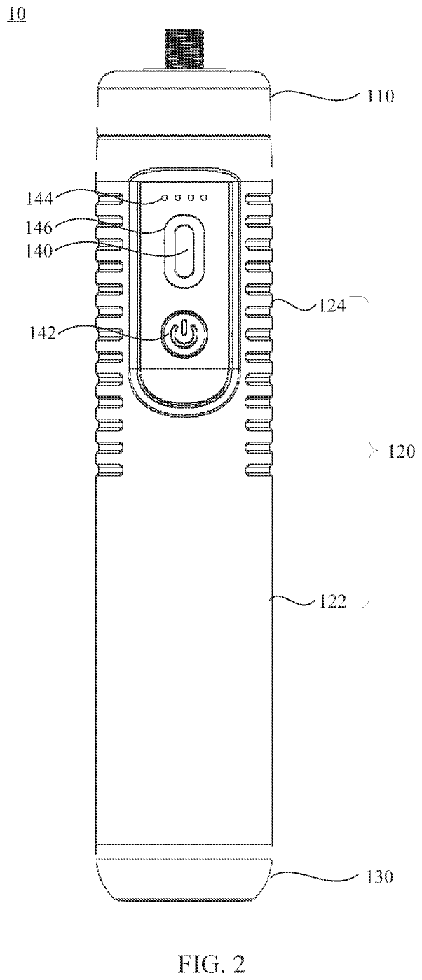

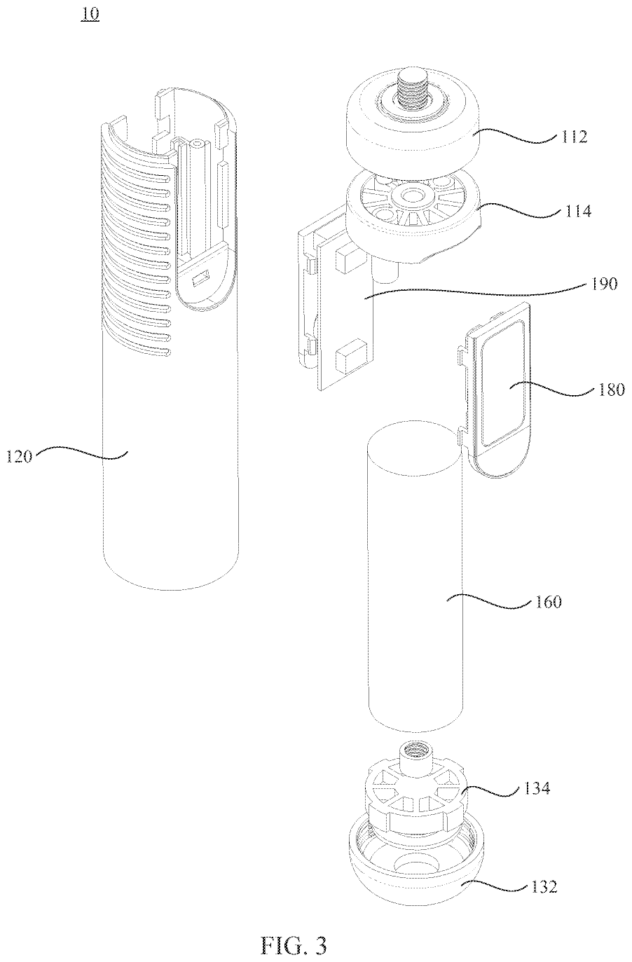

The embodiments of the present disclosure provide a mobile power supply, please refer to FIGS. 1-3. FIG. 1 is a structural schematic diagram of a mobile power supply 10 according to one embodiment of the present disclosure. FIG. 2 is a structural schematic diagram of the mobile power supply 10 shown in FIG. 1 where the mobile phone supply 10 is shown in another angle. FIG. 3 is an exploded schematic diagram of the mobile power supply 10 shown in FIG. 1. The mobile power supply 10 includes a shell 120, a charging interface 140, a battery 160, and a light supplementing lamp 180. The shell 120 serves as a main outer frame structure of the mobile power supply 10. At least one part of the shell 120 is in a cylindrical shape, the shell 120 is configured to bear a photographing device, and the shell is fixedly connected with the photographing device. The charging interface 140 is disposed on the shell 120, and the charging interface 140 is configured to be electrically connected to the photographing device. The photographing device may be a photographing device such as a camera or a video camera.

The charging interface 140 is configured according to requirements, for example, the charging interface 140 may be a Type-C interface. Certainly, the charging interface 140 may further be configured as other types of structures according to the requirements, such as a USB interface, a Micro-USB interface, etc. The charging interface 140 is at least partially exposed to the shell 120 to be connected to an external photographing device.

The battery 160 is disposed in the shell 120, and the battery 160 is configured to charge the photographing device through the charging interface 140, thereby improving working duration and endurance capability of the photographing device.

The battery 160 may be a rechargeable battery 160, such as a lithium battery 160. A capacity of the battery 160 may be configured according to the requirements, such as 4000 mAh, 5000 mAh, 6000 mAh, etc., and a working voltage of the battery 160 is 3.7V A wire connecting the battery may use a 1.8*50 mm 2P2.0 terminal wire in a positive direction.

The light supplementing lamp 180 is disposed on the shell 120, and the light supplementing lamp 180 is configured as an external light source of the photographing device. The light supplementing lamp 180 provides greater brightness, so as to provide a sufficient external light source when the photographing device captures an image, thereby improving a photographing effect of the photographing device. A type of the light supplementing lamp 180 may be configured according to the requirements, and the embodiments do not limit the type of the light supplementing lamp 180. For example, the light supplementing lamp 180 may be a plurality of LED lights. For another example, the light supplementing lamp 180 may include eight 0.6*3.0*3.3 mm3 strong light beads.

The mobile power supply 10 in the embodiments of the present disclosure not only charges a photographing device, but also provides the light supplementing lamp 180 to cooperate with the photographing device for shooting, so that shooting effect of the photographing device is improved. For example, in a case of insufficient light, the light supplementing lamp 180 cooperates with the photographing device for light supplementing and photographing. In addition, the shell 120 of the mobile power supply 10 not only carries the photographing device, but also is fixedly connected with the photographing device. A user may lift the photographing device through holding the mobile power supply 10, and it is not necessary to hold the mobile power supply 10 and the photographing device at the same time, which is convenient for the user to carry and use the photographing device and the mobile power supply 10. The shell 120 of the mobile power supply 10 has at least one part in a cylindrical structure, and the cylindrical structure is very convenient for the user to hold with single hand. The user may hold and move the mobile power supply 10 conveniently by holding the cylindrical shell 120 with the single hand, so that the photographing device fixedly connected with the mobile power supply 10 is further moved along with the mobile supply, and when the mobile power supply 10 charges the photographing device, the photographing device may continue to capture images Compared with a rectangular mobile power supply 10 or a square mobile power supply 10 for charging a mobile phone, the mobile power supply 10 of the embodiments may be installed on a photographing device as a hand-held handle to assist shooting, the mobile power supply 10 may solve the shooting requirements of the photographing device that cannot replace the battery 160 for a long time, and the mobile power supply 10 may further carry out light supplementing shooting under the case of insufficient light.

An input voltage and an input current of the mobile power supply 10 is configured according to the requirements, for example, the input voltage is 5V, and the input current is 2 A, the battery of the mobile power supply is charged using a 5V2 A charger through the charging interface (such as a TYPE-C port) of the mobile power supply. Certainly, the input voltage and the input current may further be other values, such as 5V and 1 A, or 9 V and 2 A, or 12V and 1 A, etc. Optionally, the output voltage and the output current of the mobile power supply 10 is configured according to the requirements, for example, the output voltage is 5V, the output current is 2 A, and of course, the output voltage and the output current may further be other values, such as 5V and 1 A, or 5V and 1.5 A, etc. In some examples, the mobile power supply supplies power to a photographing device (such as a camera) through the charging interface (such as the Type-C port) or charges other devices (such as a mobile phone).

In order to reduce a power consumption of the mobile power supply 10, the mobile power supply 10 may perform sleep processing on output. For example, if an output end of the mobile power supply 10 does not detect a load and lasts for 5-10 minutes, the output end of the mobile power supply 10 may be automatically disconnected, so that the self-power consumption is reduced. In another example, if the output end of the mobile power supply 10 does not detect the load, the output end of the mobile power supply 10 is automatically disconnected after 30-40 seconds, so that the output of the mobile power supply 10 is subjected to sleep processing and the self-power consumption is reduced.

The shell 120 includes a holding part 122 and a functional part 124, the light supplementing lamp 180 and the charging interface 140 are disposed in the functional part 124, and the holding part 122 is in the cylindrical shape, so that the user may conveniently hold the mobile power supply 10 without affecting use of the light supplementing lamp 180 and the charging interface 140 of the mobile power supply 10. The holding part 122 and the functional part 124 may be adjacent to each other. For example, one end of the holding part 122 is connected to the functional part 124.

It should be noted that a number of the holding part 122 and the functional part 124 may be one. In addition, in some alternative embodiments, the number of the holding parts may be two or more, and the holding parts are disposed at two ends of the functional part.

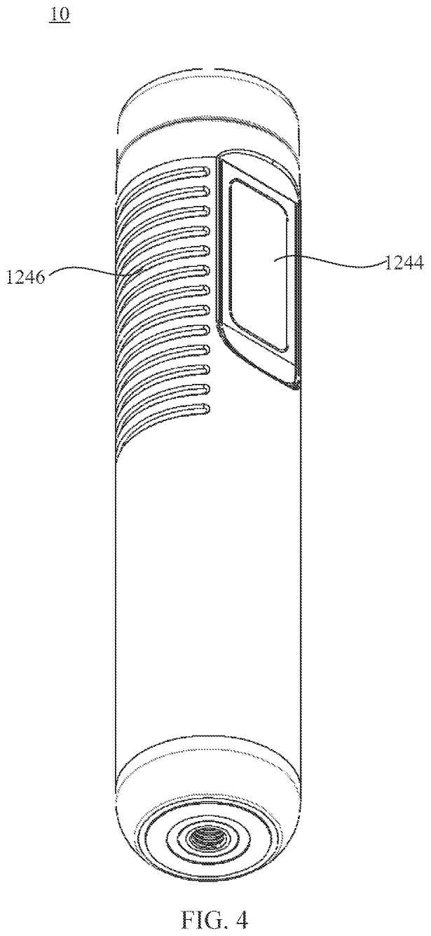

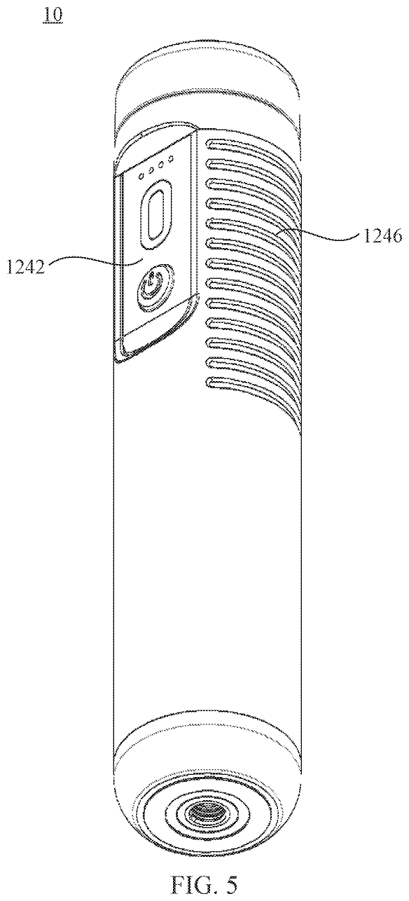

Referring to FIGS. 4-5, FIG. 4 is a structural schematic diagram of the mobile power supply shown in FIG. 1 where the mobile phone supply 10 is shown in another angle, and FIG. 5 is a structural schematic diagram of the mobile power supply shown in FIG. 1 where the mobile phone supply 10 is shown in another angle. The functional part 124 includes a first flat area 1242 and a second flat area 1244 where the first flat area 1242 and the second flat area 1244 are oppositely disposed, and two arc-shaped areas 1246 oppositely disposed. The first flat area 1242 and the second flat area 1244 are connected through the two arc-shaped areas 1246. The charging interface 140 is disposed in the first flat area 1242, and the light supplementing lamp 180 is disposed in the second flat area 1244. The first flat area 1242 and the second flat area 1244 may be conveniently provided with functional devices such as the charging interface 140 the light supplementing lamp 180, etc. An axis corresponding to the arc-shaped areas 1246 may coincide with an axis of the holding part 122. Radius of the arc-shaped areas 1246 and a radius of the holding part 122 may be equal.

A light-emitting surface of the light supplementing lamp 180 may be exposed to the shell 120, namely that, no other structure of the mobile power supply 10 blocks light of the light supplementing lamp 180, so that the light supplementing lamp 180 may provide maximum brightness to the photographing device. In some other embodiments, the shell 120 may include a light transmitting board, and the light-emitting surface of the light supplementing lamp 180 is disposed on one side of the light transmitting board facing an interior of the shell 120, namely that, light of the light supplementing lamp 180 passes through the light transmitting board to be provided to the photographing device. The light transmitting board may be disposed according to the requirements, for example, the light transmitting board may be made of glass or resin boards or plastic boards with high light transmittance, etc.

The functional part 124 and the holding part 122 may be integrally formed, for example, formed by a blow molding process. The functional part 124 and the holding part 122 may further be separately formed, and then the functional part 124 and the holding part 122 are fixedly connected in such a manner as gluing, heat-plastic, etc.

The mobile power supply 10 further includes a control button 142. The control button 142 is electrically connected with the light supplementing lamp 180, and the control button 142 is configured to control the light supplementing lamp 180 to switch different brightness levels.

The control button 142 may be a physical button, and the control button 142 is exposed to the shell 120, so that the user may press the control button 142. The control button 142 may control the light supplementing lamp 180 to switch different brightness levels through identifying a number of pressing times of the user. For example, if the control button 142 recognizes that the user presses once, the light supplementing lamp 180 is controlled to work at a lowest brightness level. If the control button 142 recognizes that the user presses twice, the light supplementing lamp 180 is controlled to work at a medium brightness level. If the control button 142 recognizes that the user presses three times, the light supplementing lamp 180 is controlled to work at a highest brightness level. If the control button 142 recognizes that the user presses four times, the light supplementing lamp 180 is controlled to flash, namely that, flash is provided. If the control button 142 recognizes that the user presses more than four times, the light supplement lamp 180 may be controlled to work at a corresponding brightness level according to a remainder of dividing the number of times by the user by four. If the current light supplementing lamp 180 is in an off state, the light supplementing lamp 180 is controlled to be turned on, and the light supplementing lamp 180 is controlled to work at the lowest brightness level or a brightness level before quenching. If the current light supplementing lamp 180 is in a working state, the light supplementing lamp 180 is controlled to extinguish. In order to better understand a control mode of the control button, following examples are illustrated. In some examples, pressing the control button for a first time controls the light supplementing lamp to turn on a small gear (low light). Pressing the control button for a second time controls the light supplementing lamp to turn on a mid-range (medium light). Pressing the control button for a third time controls the light supplementing lamp to turn on a large gear (strong light). Pressing the control button for a fourth time controls the light supplementing lamp to turn on intermittence (flash). Long pressing the control button turns off the light supplementing lamp.

It should be noted that the above embodiment illustrates that the light supplementing lamp 180 has three brightness levels. In some other embodiments, the brightness level of the light supplementing lamp 180 may be configured according to the requirements, for example, level 2, level 4, level 5, or more. Similarly, different brightness levels may be switched through the control button 142 to recognize the number of times the user presses, please refer to the above-mentioned embodiment, and details are not described herein again.

In some other embodiments, the control button may further be another type of button, such as a touch button or a light sensation button. According to the embodiments of the present disclosure, the type of the control button is not limited, and as long as function buttons capable of realizing functions are all within the protection scope of the present disclosure.

The control button 142 is disposed in the first flat area 1242. The control button 142 and the charging interface 140 may be both disposed on the first flat area 1242, facilitating an arrangement of the functional devices such as the control button 142 and the charging interface 140, and further facilitating a setting of an internal circuit.

The mobile power supply 10 further includes a plurality of prompting lamps 144, and the plurality of prompting lamps 144 are configured to prompt remaining power of the battery 160. Specifically, different numbers of the prompting lamps 144 among the plurality of prompting lamps 144 are lit or flashed to indicate the remaining power of the battery 160. For example, the mobile power supply 10 includes four prompting lamps 144. When the battery 160 is charging the photographing device, if three of the prompting lamps 144 or the third prompting lamp 144 flashes, it indicates that the battery 160 has 3/4 power remaining. For another example, the mobile power supply 10 includes four prompting lamps 144. When an external power supply is charging the battery 160, if two of the prompting lamps 144 or the second prompting lamp 144 flashes, it indicates that the battery 160 has been charged to 2/4 capacity. Colors of the plurality of prompting lamps 144 may be configured according to the requirements, such as one of red, blue, orange, green, and emerald green. In some examples, when the mobile power supply is discharging, the plurality of prompting lamps (such as 4 emerald green LEDs) flash, and each LED flashes in sequence according to a battery percentage of each LED. When the mobile power supply is charging, the plurality of prompting lamps (such as 4 emerald green LEDs) flash, and each LED flashes in sequence according to the battery percentage of each LED light.

The plurality of prompting lamps 144 may be disposed side by side, so that a space may be saved, and the user may conveniently and quickly know the remaining power of the battery 160.

The mobile power supply 10 further includes at least one signal lamp 146, and the at least one signal lamp 146 is configured to prompt the battery 10 to be in a charging state or in a discharging state, so that the user may quickly know the working state of the mobile power supply 10. When the battery 160 is in the charging state or in the discharging state, the signal lamp 146 may flash or be turned on to prompt the working state of the battery 160.

The mobile power supply 10 may include one signal lamp 146, and a color of the signal lamp 146 may be configured according to the requirements, such as one of red, blue, orange, green, etc. The mobile power supply 10 may include two signal lamps 146, and the colors of the signal lamps 146 may be configured according to the requirements, such as two of red, blue, orange, green, etc. When the battery 160 is in the charging state, one of the signal lamps 146 (e.g., the orange signal lamp 146) flashes or is always on. When the battery 160 is in the discharging state (i.e., the battery 160 is charging the photographing device), another signal lamp 146 (e.g., the blue signal lamp 146) flashes or is always on. In some examples, the signal lamp indicating charging and discharging may be a breathing light (such as 4 milky white LEDs), and the breathing light may be displayed from weak to strong.

The signal lamps 146 may further be disposed around the charging interface 140 to facilitate user viewing. In some other embodiments, the signal lamps may further be disposed adjacent to the charging interface, for example, the signal lamps are disposed side by side with the charging interface.

The shell 120 further includes a connecting plug 110 and a connecting socket 130, the connecting plug 110 and the connecting socket 130 are respectively disposed at two opposite ends of the shell 120, the connecting plug 110 is configured to be connected with a connecting socket 130 of other device (such as a photographing device), and the connecting socket 130 is configured to be connected with a connecting plug 110 of other device (such as a tripod).

The connecting plug 110 and the connecting socket 130 may be a connection port corresponding to a standard 1/4 inch interface in the photographing device, the connecting plug 110 may be connected to the photographing device, and the connecting socket 130 may be connected to the tripod. Exemplarily, the connecting plug HO may include a screw connecting portion 112 and a base 114. The base 114 is fixedly connected to the shell 120, the screw connecting portion 112 is disposed on one side, distal from the shell 120, of the base 114. The screw connecting portion 112 includes a screw column connected to the photographing device, and the screw column protrudes toward a side distal from the base 114. The screw connecting portion 112 may include the screw column, an outer cover, and a screw base. The screw base is fixedly connected with the base. The screw base includes a side having a first gear and facing the screw column. The screw column includes a second side having a second gear and facing the screw base. The screw column and the screw base are connected through a first gear and a second gear. The outer cover is provided with an opening corresponding to the screw column, the outer cover covers a bottom of the screw column, and a top of the screw column is exposed. The outer cover is spirally connected with an outer wall of the screw base so as to fix the screw column and expose the top with the thread. The connecting socket 130 includes a cover 132 and a screw seat 134, a threaded hole is defined on the screw seat 134, the cover 132 covers the screw seat 134, the cover 132 is fixedly connected to the shell 120, and the cover 132 exposes the threaded hole. Certainly, in some other embodiments, the connecting plug and the connecting socket may further be other connecting ports, such as screws and nuts matched with each other.

A first opening and a second opening may be defined on the first flat area 1242. The first opening corresponds to the control button 142. The second opening corresponds to the charging interface 140. A third opening is defined on the second flat area 1244. The third opening corresponds to the light supplementing lamp 180.

In order to better understand the mobile power supply of the embodiment of the present disclosure, a production process of the mobile power supply is described below. Exemplarily, obtaining the battery such as a lithium battery PACK, spraying silk screen printing on a casing of the mobile power supply, putting the lithium battery into a plastic case, connecting positive and negative terminals of the lithium battery to a booster board, connecting a light supplementing board to a power supply board, then assembling all devices as a whole, then carrying out test processes such as test function, aging, retest, etc., and finally, packing and shipping.

The mobile power supply 10 further includes a circuit board 190, the circuit board 190 is disposed in the shell 120, and the circuit board 190 is connected with the battery 160 to control charging and discharging of the battery.

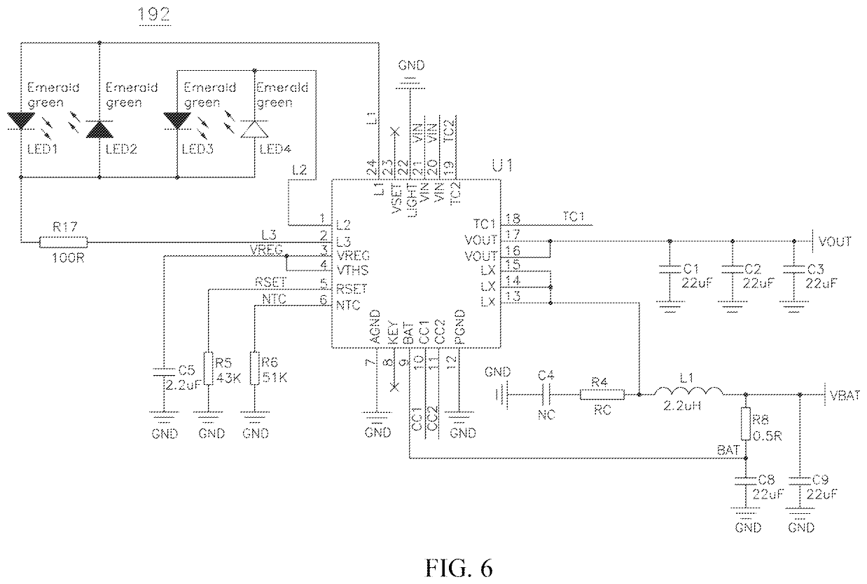

Referring to FIG. 6, FIG. 6 is a circuit diagram of a first driving circuit according to one embodiment of the present disclosure. The circuit board 190 includes a first driving circuit 192. The first driving circuit 192 includes a first control chip U1 and a seventeenth resistor R17 The first control chip U1 includes a first pin L1, a second pin L2, and a third pin L3. The mobile power supply 10 further includes a first prompting lamp LED1, a second prompting lamp LED2, a third prompting lamp LED3, and a fourth prompting lamp LED4. A positive electrode of the first prompting lamp LED1 is connected with the first pin L1, and a negative electrode of the first prompting lamp LED1 is connected with the third pin L3 through the seventeenth resistor R17. A negative electrode of the second prompting lamp LED2 is connected with the first pin L1, and a positive electrode of the second prompting lamp LED2 is connected with the third pin L3 through the seventeenth resistor R17, A positive electrode of the third prompting lamp LED3 is connected with the second pin L2, and a negative electrode of the third prompting lamp LED3 is connected with the third pin L3 through the seventeenth resistor. A negative electrode of the fourth prompting lamp LED4 is connected with the second pin L2, and a positive electrode of the fourth prompting lamp LED4 is connected with the third pin L3 through the seventeenth resistor R17.

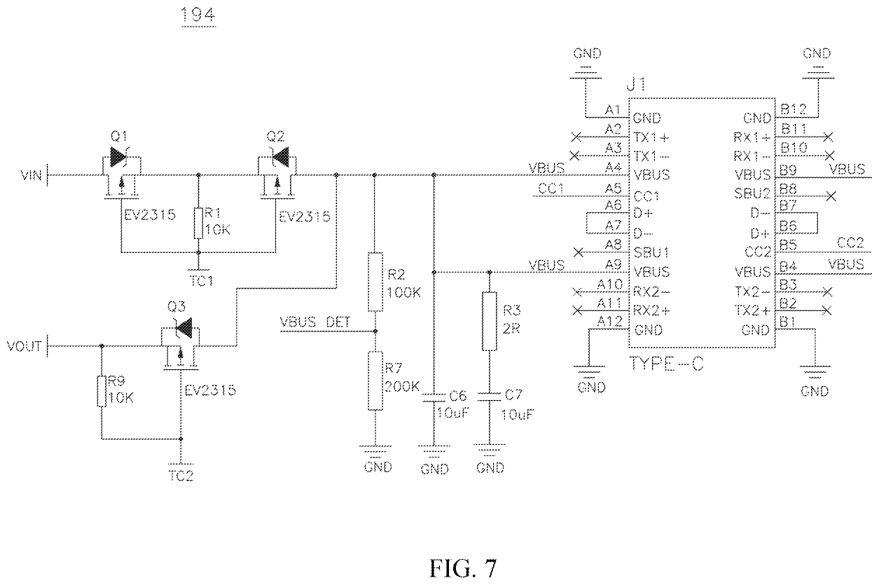

Referring to FIG. 7, FIG. 7 is a circuit diagram of a charging and discharging matching circuit according to one embodiment of the present disclosure. The circuit board 190 further includes a charging and discharging matching circuit 194. The charging and discharging matching circuit 194 includes a first resistor R1, a first transistor Q1, a second transistor Q2, a ninth resistor R9, and a third transistor Q3. One end of the first resistor R1 is connected with the first control pin TC1 of the first control chip U1. A grid electrode of the first transistor Q1 is connected with the first control pin TC1, a drain electrode of the first transistor Q1 is connected with a voltage input pin VIN of the first control chip U1, and a source electrode of the first transistor Q1 is connected with an other end of the first resistor R1. A grid electrode of the second transistor Q2 is connected with the first control pin TC1, a drain electrode of the second transistor Q2 is connected with the charging interface 140, and a source electrode of the second transistor Q2 is connected with the other end of the first resistor R1. One end of the ninth resistor R9 is connected with a voltage output pin VOUT of the first control chip U1. A grid electrode of the third transistor Q3 is connected with the second control pin TC2 of the first control chip U1, the grid electrode of the third transistor Q3 is further connected with an other end of the ninth resistor 19, a source electrode of the third transistor Q3 is connected with the voltage output pin STOUT, and a drain electrode of the third transistor Q3 is connected with the charging interface 140.

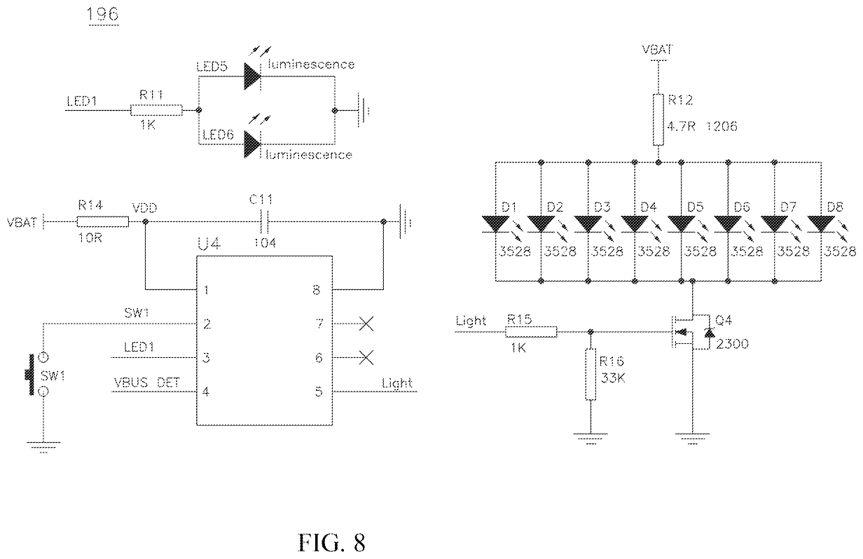

Referring to FIG. 8, FIG. 8 is a circuit diagram of a second driving circuit and a second matching circuit according to one embodiment of the present disclosure. The circuit board 190 includes a second driving circuit 196, and the second driving circuit 196 includes a second control chip U4 and a first matching circuit. The second control chip U4 includes a switching pin SW1 and a first output pin Light, and the switching pin SW1 is configured to receive a signal of a control switch. The first matching circuit includes a twelfth resistor R12, a fifteenth resistor R15, a sixteenth resistor R16, and a fourth transistor Q4. One end of the twelfth resistor R12 is connected with an other end of the battery 160, and an other end of the twelfth resistor R12 is connected with a positive electrode of the light supplementing lamp (D1-D8). One end of the fifteenth resistor R15 is connected with the first output pin Light, an other end of the fifteenth resistor 115 is connected with a grid electrode of the first transistor Q1, and the other end of the fifteenth resistor R15 is electric grounding through the sixteenth resistor R16. The drain electrode of the first transistor Q1 is connected with a negative electrode of the light supplementing lamp 180, and the source electrode of the first transistor Q1 is electric grounding.

The second driving circuit 196 further includes a second matching circuit. The second matching circuit includes an eleventh resistor R11. One end of the eleventh resistor RH is connected with a second output pin of the second control chip U4, an other end of the eleventh resistor R11 is connected with a positive electrode of the signal lamps (LED5 and LED6), and a negative electrode of the signal lamps is electric grounding.

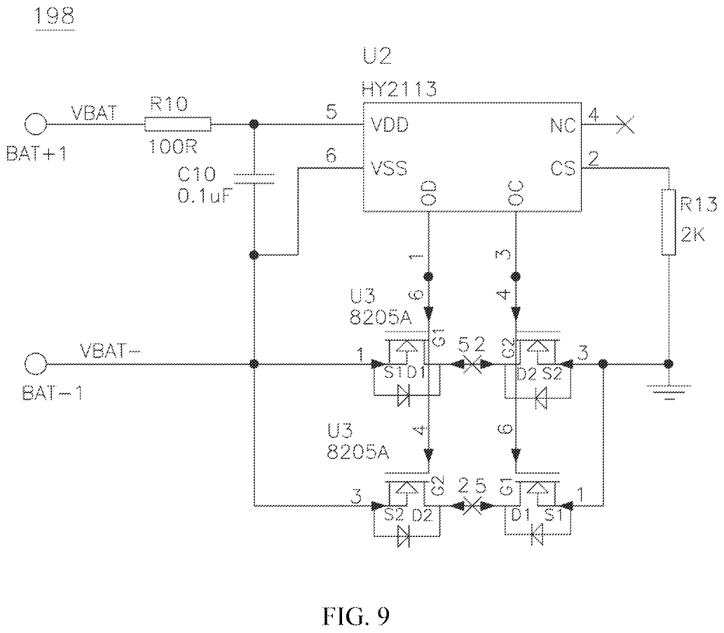

Referring to FIG. 9, FIG. 9 is a circuit diagram of a third driving circuit according to one embodiment of the present disclosure. The circuit board 190 further includes a third driving circuit 198. The third driving circuit 198 includes a third control chip U2, a fifth transistor, a sixth transistor, a seventh transistor, and an eighth transistor.

The third control chip U2 includes a power supply pin, a VSS pin, a CS pin, a first charging and discharging control pin OD, and a second charging and discharging control pin OC. A grid electrode of the fifth transistor is connected with the first charging and discharging control pin OD, and a source electrode of the fifth transistor is connected with the VSS pin. A grid electrode of the sixth transistor is connected with the first charging and discharging control pin, and a source electrode of the sixth transistor is connected with the VSS pin. A grid electrode of the seventh transistor is connected with the second charging and discharging control pin OC, a source electrode of the seventh transistor is electric grounding through a VSS port, and a drain electrode of the seventh transistor is connected with a drain electrode of the fifth transistor. A grid electrode of the eighth transistor is connected with the second charging and discharging control pin OC, a source electrode of the eighth transistor is electric grounding through the VSS port, and a drain electrode of the eighth transistor is connected with a drain electrode of the sixth transistor. The fifth transistor and the sixth transistor may be two independent MOS transistors, and may further be a double MOS transistor as shown in FIG. 9. The sixth transistor and the seventh transistor may be two independent MOS transistors, and may further be a double MOS transistor as shown in FIG. 9.

The third driving circuit 198 further includes a tenth resistor R10, a thirteenth resistor 113, and a tenth capacitor C10, One end of the tenth resistor R10 is connected with the power supply pin, and an other end of the tenth resistor is connected with a positive electrode of the battery 160. One end of the thirteenth resistor R13 is connected with the CS pin, and an other end of the thirteenth resistor is electric grounding. One end of the tenth capacitor C10 is connected with the power supply pin, and an other end of the tenth capacitor C10 is connected with the VSS pin.

The mobile power supply provided by the embodiments of the present disclosure has been described in detail above. Specific examples are used herein to illustrate principles and implementations of the present disclosure, and descriptions of the above embodiments are only configured to help understand methods and core ideas of the present disclosure. At the same time, for the person skilled in the art, according to the ideas of the present disclosure, there will be changes in the specific embodiments and application scope. In summary, a content of the specification should not be construed as a limitation to the present disclosure.

What is claimed is:

1. A mobile power supply, comprising:
a shell;
a charging interface;
a battery; and
a light supplementing lamp;
wherein at least one part of the shell is in a cylindrical shape; the shell is configured to bear a photographing device, the shell is fixedly connected with the photographing device;
the charging interface is disposed on the shell, the charging interface is configured to be electrically connected to the photographing device;
the battery is disposed in the shell, the battery is configured to charge the photographing device through the charging interface;
the light supplementing lamp is disposed on the shell, and the light supplementing lamp is configured as an external light source of the photographing device.

2. The mobile power supply according to claim 1, wherein the shell comprises a holding part and a functional part, the light supplementing lamp and the charging interface are disposed in the functional part, and the holding part is in the cylindrical shape.

3. The mobile power supply according to claim 2, wherein the functional part comprises a first flat area and a second flat area where the first flat area and the second flat area are oppositely disposed, and two arc-shaped areas oppositely disposed; the first flat area and the second flat area are connected through the two arc-shaped areas; and
the charging interface is disposed in the first flat area, and the light supplementing lamp is disposed in the second flat area.

4. The mobile power supply according to claim 3, wherein the mobile power supply further comprises a control button; the control button is electrically connected with the light supplementing lamp, and the control button is configured to control the light supplementing lamp to switch different brightness levels.

5. The mobile power supply according to claim 4, wherein the control button is disposed in the first flat area.

6. The mobile power supply according to claim 1, wherein the mobile power supply further comprises a plurality of prompting lamps, and the plurality of prompting lamps are configured to prompt remaining power of the battery.

7. The mobile power supply according to claim 6, wherein the plurality of prompting lamps are disposed side by side.

8. The mobile power supply according to claim 1, wherein the mobile power supply further comprises at least one signal lamp, and the at least one signal lamp is configured to prompt the battery to be in a charging state or in a discharging state.

9. The mobile power supply according to claim 8, wherein the signal lamp is disposed around the charging interface.

10. The mobile power supply according to claim 1, wherein the shell further comprises a connecting plug and a connecting socket, the connecting plug and the connecting socket are respectively disposed at two opposite ends of the shell, the connecting plug is configured to be connected with a connecting socket of other device, and the connecting socket is configured to be connected with a connecting plug of other device.

11. The mobile power supply according to claim 1, wherein the mobile power supply further comprises a circuit board, the circuit board is disposed in the shell, and the circuit board is connected with the battery to control charging and discharging of the battery.

12. The mobile power supply according to claim 11, wherein the circuit board comprises a first driving circuit, the first driving circuit comprises a first control chip and a seventeenth resistor, the first control chip comprises a first pin, a second pin, and a third pin; the mobile power supply further comprises a first prompting lamp, a second prompting lamp, a third prompting lamp, and a fourth prompting lamp;
a positive electrode of the first prompting lamp is connected with the first pin, a negative electrode of the first prompting lamp is connected with the third pin through the seventeenth resistor;
a negative electrode of the second prompting lamp is connected with the first pin, a positive electrode of the second prompting lamp is connected with the third pin through the seventeenth resistor;
a positive electrode of the third prompting lamp is connected with the second pin, a negative electrode of the third prompting lamp is connected with the third pin through the seventeenth resistor;
a negative electrode of the fourth prompting lamp is connected with the second pin, and a positive electrode of the fourth prompting lamp is connected with the third pin through the seventeenth resistor.

13. The mobile power supply according to claim 12, wherein the circuit board further comprises a charging and discharging matching circuit, the charging and discharging matching circuit comprises a first resistor, a first transistor, a second transistor, a ninth resistor, and a third transistor;
one end of the first resistor is connected with the first control pin of the first control chip;
a grid electrode of the first transistor is connected with the first control pin, a drain electrode of the first transistor is connected with a voltage input pin of the first control chip, a source electrode of the first transistor is connected with an other end of the first resistor;
a grid electrode of the second transistor is connected with the first control pin, a drain electrode of the second transistor is connected with the charging interface, a source electrode of the second transistor is connected with the other end of the first resistor;
one end of the ninth resistor is connected with a voltage output pin of the first control chip;
a grid electrode of the third transistor is connected with the second control pin of the first control chip, the grid electrode of the third transistor is further connected with an other end of the ninth resistor, a source electrode of the third transistor is connected with the voltage output pin, and a drain electrode of the third transistor is connected with the charging interface.

14. The mobile power supply according to claim 13, wherein the circuit board comprises a second driving circuit, the second driving circuit comprises a second control chip and a first matching circuit;
the second control chip comprises a switching pin and a first output pin, the switching pin is configured to receive a signal of a control switch;
the first matching circuit comprises a twelfth resistor, a fifteenth resistor, a sixteenth resistor, and a fourth transistor; one end of the twelfth resistor is connected with an other end of the battery, an other end of the twelfth resistor is connected with a positive electrode of the light supplementing lamp; one end of the fifteenth resistor is connected with the first output pin, an other end of the fifteenth resistor is connected with a grid electrode of the first transistor, the other end of the fifteenth resistor is electric grounding through the sixteenth resistor, the drain electrode of the first, transistor is connected with a negative electrode of the light supplementing lamp, and the source electrode of the first transistor is electric grounding.

15. The mobile power supply according to claim 14, wherein the circuit board further comprises a second matching circuit, the second matching circuit comprises an eleventh resistor, one end of the eleventh resistor is connected with a second output pin of the second control chip, an other end of the eleventh resistor is connected with a positive electrode of the signal lamp, and a negative electrode of the signal lamp is electric grounding.

16. The mobile power supply according to claim 11, wherein the circuit board further comprises a third driving circuit, the third driving circuit comprises a third control chip, a fifth transistor, a sixth transistor, a seventh transistor, and an eighth transistor;
the third control chip comprises a power supply pin, a VSS pin, a CS pin, a first charging and discharging control pin, and a second charging and discharging control pin;
a grid electrode of the fifth transistor is connected with the first charging and discharging control pin, a source electrode of the fifth transistor is connected with the VSS pin;
a grid electrode of the sixth transistor is connected with the first charging and discharging control pin, a source electrode of the sixth transistor is connected with the VSS pin;
a grid electrode of the seventh transistor is connected with the second charging and discharging control pin, a source electrode of the seventh transistor is electric grounding through a VSS port, a drain electrode of the seventh transistor is connected with a drain electrode of the fifth transistor;
a grid electrode of the eighth transistor is connected with the second charging and discharging control pin, a source electrode of the eighth transistor is electric grounding through the VSS port, and a drain electrode of the eighth transistor is connected with a drain electrode of the sixth transistor.

17. The mobile power supply according to claim 11, wherein the third driving circuit further comprises a tenth resistor, a thirteenth resistor, and a tenth capacitor;
one end of the tenth resistor is connected with the power supply pin; an other end of the tenth resistor is connected with a positive electrode of the battery;
one end of the thirteenth resistor is connected with the CS pin, an other end of the thirteenth resistor is electric grounding;
one end of the tenth capacitor is connected with the power supply pin, and an other end of the tenth capacitor is connected with the VSS pin.
